(19) United States
(12) Patent Application Publication
(10) Pub. No.: US 2018/0134021 A1
(43) Pub. Date: May 17, 2018

(54) PNEUMATIC POSITIONING OF LAMINATOR ROLLERS

(71) Applicant: Vivid Laminating Technologies Limited, Coalville, Leicestershire (GB)

(72) Inventor: Gavin Ward, Coalville, Leicestershire (GB)

(21) Appl. No.: 15/574,273

(22) PCT Filed: May 13, 2016
(86) PCT No.: PCT/GB2016/051380

§ 371 Date: Nov. 15, 2017

(30) Foreign Application Priority Data
May 15, 2015 (GB) 1508394.2
Nov. 30, 2015 (GB) 1521053.7

(51) Int. Cl. B32B 37/00; B32B 41/00

(52) U.S. Cl. CPC B32B 37/0053; B32B 41/00

(57) ABSTRACT

A laminator comprises first and second rollers mounted in parallel for counter-rotation. One of the rollers is supported on a pair of pneumatic cylinders, which can be operated to adjust the gap between the rollers. When a desired gap is reached for the thickness of workpiece to be laminated, locks can be operated to prevent further movement of the first roller towards the second roller. Preferably the locks do not prevent movement of the first roller away from the second roller. After the locks have been engaged to protect the workpiece against crushing, the pressure applied to the first roller during the laminating process can be changed.

### TECHNICAL FIELD

The invention relates to laminators in which a workpiece to be laminated is fed through the gap between a pair of parallel, counter-rotating rollers. The workpiece comprises a sheet to be laminated, together with laminating film to be applied to one or both surfaces of the sheet. The gap between the rollers needs to be adjusted according to the thickness of the workpiece in order that the desired pressure may be applied during the laminating process.

### BACKGROUND OF THE INVENTION

The first roller of the pair is mounted such that it can be moved towards or away from the second roller in order to adjust the size of the gap between them. The first roller is normally arranged above the second roller so that the workpiece rests on the second roller. Means are provided for lowering the first roller until it comes into contact with the workpiece and presses the workpiece against the second roller. At the end of the process the first roller is raised to release the workpiece or to reset the apparatus.

It is known to adjust the gap between the rollers by purely mechanical means, typically controlled by a wheel on one end of a shaft that extends across the laminator. The wheel is turned manually to rotate the shaft, which then acts through gearing to raise or lower the mounting at each end of the first roller. The height of the roller is adjustable through a continuous range and at any height a desired pressure can be applied by turning the wheel to a suitable position. However, the mechanical system has the disadvantage that, owing to manufacturing tolerances or wear, it might not move the two ends of the first roller by exactly equal amounts. As a result, uneven pressure can be applied across the width of the workpiece.

As an alternative, it is known to adjust the gap by pneumatic means. Each end of the first roller is supported on a pneumatic cylinder. By applying pressurized air to the respective cylinders the first roller can be moved towards the second roller. The pneumatic system has the advantages that it can be actuated by the push of a button and that if both cylinders are supplied from a common source of pressurized air, they are guaranteed to apply equal pressure to the first roller so pressure should be applied evenly across the width of the workpiece to the laminated.

A disadvantage of the pneumatic system is that the pressure applied to move the first roller into position and maintain it there may be greater than the material of some workpieces such as foam board can resist. Thus the roller may crush the workpiece as the first roller is brought into contact with it. Also, the pressurized air continues to act on the cylinders as successive workpieces are fed between the rollers, so that as the trailing edge of one workpiece moves out from between the rollers, they are pushed closer together until they come into contact, then the leading edge of the succeeding workpiece forces them apart again. This can cause damage to the leading and trailing edges of the workpieces.

The problem that pneumatically operated rollers may crush delicate workpieces has been recognized and a known solution is to provide an insert that can be moved between the roller mountings to prevent the rollers approaching one another more closely than a fixed, minimum distance. The insert has a stepped profile and the minimum distance is determined by the height of the selected step. Typically a few steps of different heights are provided to match standard thicknesses of workpiece but workpieces formed from the sheets and laminating materials of different manufacturers might not be exactly the same and non-standard thicknesses cannot be accommodated at all.

### SUMMARY OF THE INVENTION

The invention provides a laminator as defined in claim 1.

The invention further provides a method of configuring a laminator as defined in claim 10.

Features of the invention that are preferred but not essential are defined in the dependent claims.

The laminator according to the invention combines the advantages of the mechanical and pneumatic systems known in the prior art. The pneumatic cylinders are easily operated and can be supplied from a common source to balance the pressure at each end of the first roller. The locking assembly can be operated to prevent the gap between the rollers reducing below a minimum size. Unlike the wedges known in the prior art, this minimum size can take any value within a continuous range (or alternatively any of a large number of closely spaced discrete values). The value does not have to be chosen in advance but can be determined by the thickness of the actual workpiece.

The method according to the invention permits the first roller to be brought into engagement with the workpiece at a relatively low pressure that will avoid crushing it. The locking assembly can then be operated and, if desired, the pressure can then be made higher during the laminating process, while the workpiece remains protected against crushing.

### THE DRAWINGS

FIG. 1 is a schematic front view of the apparatus for positioning the rollers of a laminator in accordance with a first embodiment of the invention.

FIG. 2 is a schematic front view of the apparatus for positioning the rollers of a laminator in accordance with a second embodiment of the invention.

FIG. 3 is a schematic front view of the apparatus for positioning the rollers of a laminator in accordance with a third embodiment of the invention.

FIG. 4 is a schematic front view of the apparatus for positioning the rollers of a laminator in accordance with a fourth embodiment of the invention.

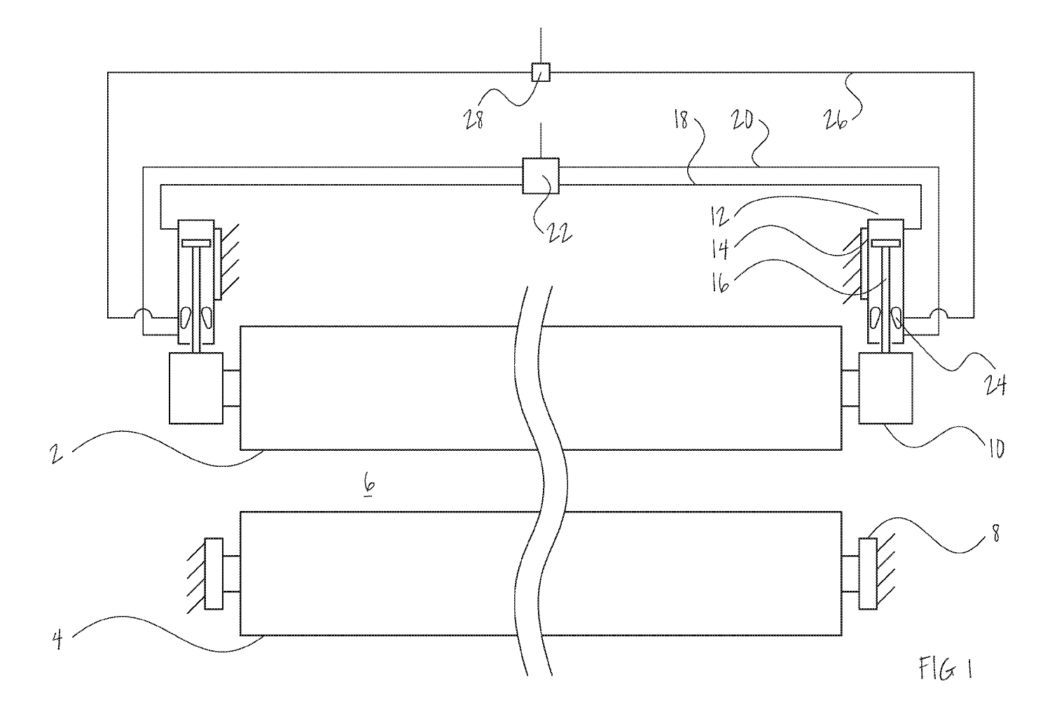

As shown in FIG. 1, a laminator in accordance with the invention comprises a first roller 2 arranged parallel to and spaced from a second roller 4. The double wavy line indicates that the rollers 2,4 may be of various lengths, including for use in a wide format laminator. Means (not shown) are provided for rotating one of the rollers and counter-rotating the other of the rollers to draw a workpiece (not shown) through the gap 6 between them. The workpiece comprises a sheet of material to be laminated, having a film of laminating material in contact with one or both sides of the sheet. The laminator operates in a conventional manner by applying heat and pressure to the layered workpiece as it passes between the rollers 2,4.

In order to accommodate workpieces of different thicknesses, the size of the gap 6 between the rollers 2,4 needs to be adjustable. The mounting 8 of the second, lower roller 4 is fixed to the body of the laminator so that the second roller always rotates about the same axis. The mounting 10 of the first roller 2 is adjustable relative to the body of the laminator so that the first roller can be moved towards or away from the second roller 4 to change the size of the gap 6, while keeping parallel the axes of the two rollers 2,4.

The respective ends of the first roller 2 are supported on a pair of pneumatic cylinders 12. Each cylinder 12 comprises a tube 14 that is fixed to the body of the laminator and a piston 16 that slides within the tube and projects from it. The mounting of the first roller 2 is supported on the projecting part of the piston 16. The head of the piston 16 divides the tube 14 into two sealed chambers, each of which is coupled to a respective line 18,20 of a drive air supply 22. The drive air supply 22 can direct pressurized air via a first line 18 into one of the chambers of the cylinder 12 to drive the piston 16 forwards and move the first roller 2 towards the second roller 4. At different times, the drive air supply 22 can direct pressurized air via a second line 20 into the other of the chambers of the cylinder 12 to drive the piston 16 back and move the first roller 2 away from the second roller 4. In an alternative arrangement (not illustrated), the backward movement of the piston can be effected by a return spring when the pressure to the first chamber is reduced. In this case, the supply line 20 to the second chamber is not required. Pneumatic control of the roller position in this way is known in the prior art and will not be described in detail here. Preferably the pressurized air is delivered to the pair of pneumatic cylinders 12 from a common supply so that the two cylinders always operate at the same pressure and move the two pistons 16 through the same distance, whereby the first roller 2 remains parallel to the second roller 4. To further ensure balance between the cylinders 12, the length of each branch of the supply line 18 from the common source to its respective cylinder should preferably be equal.

In accordance with a first embodiment of the present invention, each cylinder 12 is provided with a pneumatically-operated lock 24. The two locks 24 are coupled via supply lines 26 to a common locking air supply 28. When pressurized air from the supply 28 is applied to a lock 24, it clamps onto the piston 16 to prevent further movement of the piston out of the tube 14 and thus prevent further movement of the first roller 2 toward the second roller 4. Preferably the lock 24 acts on the piston 16 in only one direction so that the first roller 2 remains able to move away from the second roller 4, while being cushioned by the pressurized air of the drive supply 22. Each lock 24 in this embodiment comprises a pair of jaws that can be pivoted into engagement with the piston shaft to clamp the shaft between them. A range of pneumatic cylinders with locks of this kind is available from suppliers of pneumatic apparatus. It is preferred that the locks 24 should be able to engage the cylinders 12 at any position within a continuous range of movement of the first roller 2 so that workpieces of any thickness within that range can be accommodated by the laminator. However, it would be an acceptable alternative to employ locks that engage the cylinders via a series of teeth, for example in the manner of a ratchet, which would allow the roller position to be set at any of a large number of closely spaced discrete values.

A laminator according to this first embodiment of the invention may be configured in the following way. A sample workpiece is placed in the gap 6 between the first and second rollers 2,4 resting on the second roller 4. The drive air supply 22 is then operated to send pressurized air through the first supply line 18 to the two cylinders 12. This drives the first roller 2 towards the second roller 4 until its further movement is resisted by contact with the workpiece. The drive air pressure should be selected so that the roller does not crush the workpiece: for delicate workpiece materials such as foam board a relatively low pressure may be used. The locking assembly is then operated by applying pressurized air from the locking supply 28 to engage the locks 24 with the pistons 16 and provide mechanical resistance to further reduction of the gap 6 between the first and second rollers 2,4. The laminating process can then be carried out by feeding a series of workpieces through the gap 6 without the need to reset the rollers 2,4.

After the position of the rollers has been set in the manner just described, it may be desirable to change the pressure of the drive air supply 22 during operation of the laminator. For example, the pressure can be increased to ensure that the first roller 2 does not lift away from the workpiece during lamination, while the operation of the locking assembly protects the workpiece against crushing. The setup procedure may be carried out using just the sheet that is to be laminated, without the additional sheet(s) of laminating material. When the laminating material is added during the laminating process, the workpiece will be slightly thicker than it was during the setup procedure so that rollers 2,4 are forced slightly further apart than the minimum gap 6 set by the locking assembly. The pressure applied to the laminating material can therefore still be controlled through the drive air supply 22, despite the action of the locks 24.

When lamination of a series of workpieces is complete, or if it is desired to increase the gap 6, the locking air supply 28 can be cut off to disengage the locks 24. The drive air supply 22 is then switched from line 18 to line 20 to drive the pistons 16 in the opposite direction and move the first roller 2 away from the second roller 4.

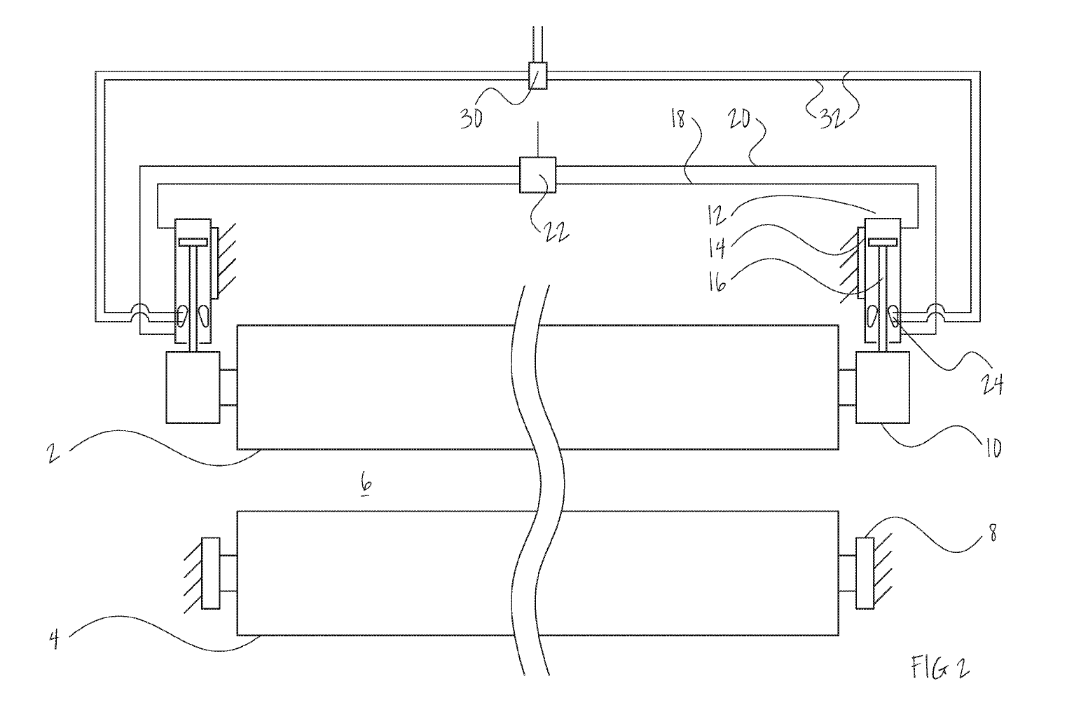

Because a pneumatic system is required for the drive air supply 22, it is generally convenient also to operate the locking assembly pneumatically, as shown in FIG. 1. However, as shown in the embodiment of FIG. 2, it is equally possible to operate the locks 24 by electromechanical means such as solenoids, which are controlled from a power supply 30 via wires 32. In all other respects the second embodiment is the same as the first embodiment.

Operation of the locks 24 by purely mechanical means is also envisaged as a further alternative.

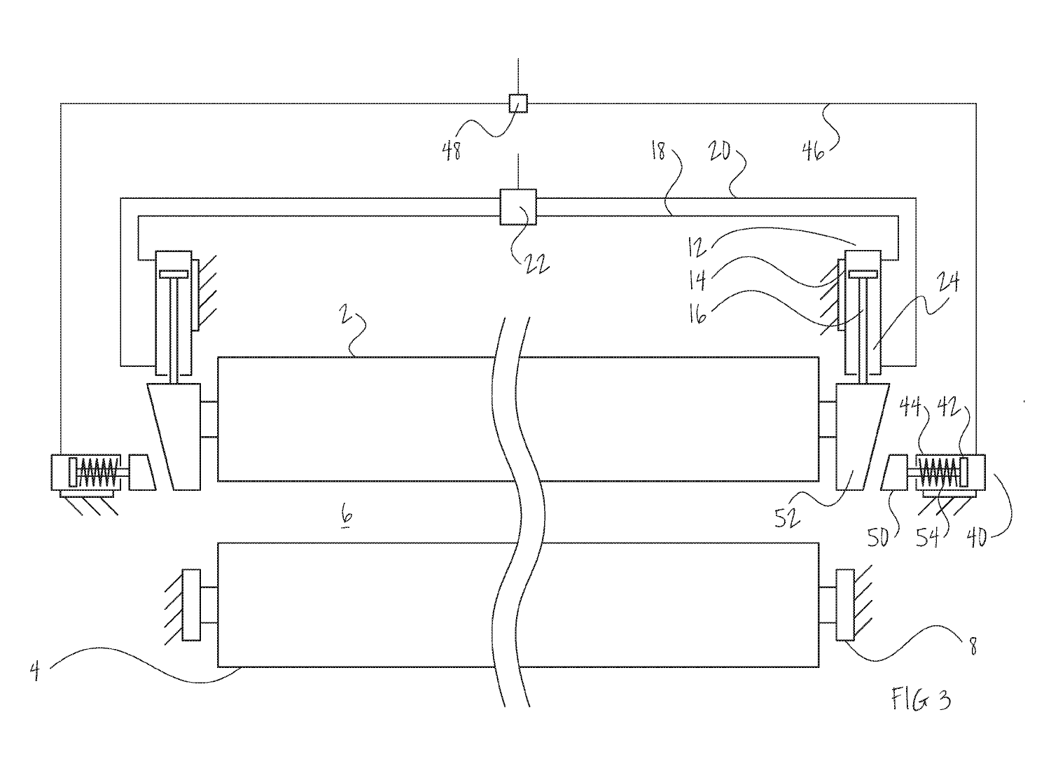

FIG. 3 schematically illustrates a third embodiment of the invention, which is the same as FIG. 1 except for the locking assembly. In this case, instead of locks 24 in the form of jaws that clamp the piston shaft between them, each lock 40 comprises its own pneumatic cylinder with a piston 42 sliding within a tube 44. The cylinder of each lock 40 is formed as part of, or is attached to, the cylinder that houses the associated piston 16, whereby each of the locks 40 is integrated within a housing of its respective cylinder.

A supply line 46 delivers pressurized air from a locking supply 48 to a chamber within the tube 44 to drive the piston 42 into a locking position. A first locking member 50 on the piston 42 engages the main piston 16 to prevent further movement of the mounting 10 and the first roller 2 that it supports towards the second roller 4. The main piston 16 may carry a second locking member (not illustrated) for better engagement with the first locking member. The mutual engagement may act as a clutch and may include engagement surfaces that are inclined relative to the direction of movement of the piston 16 in order to effect a wedging action that mechanically resists that movement in the direction towards the flatbed 4 but not in the opposite direction.

To deactivate the locking assembly in this embodiment, air pressure on the supply line 46 is cut and the piston 42 is driven back into the tube 44 by the action of a return spring 54. Alternatively, a second supply line could be provided to deliver air into the tube on the opposite side of the piston 42 from the first supply line 46 so that the piston 42 is moved pneumatically in both directions.

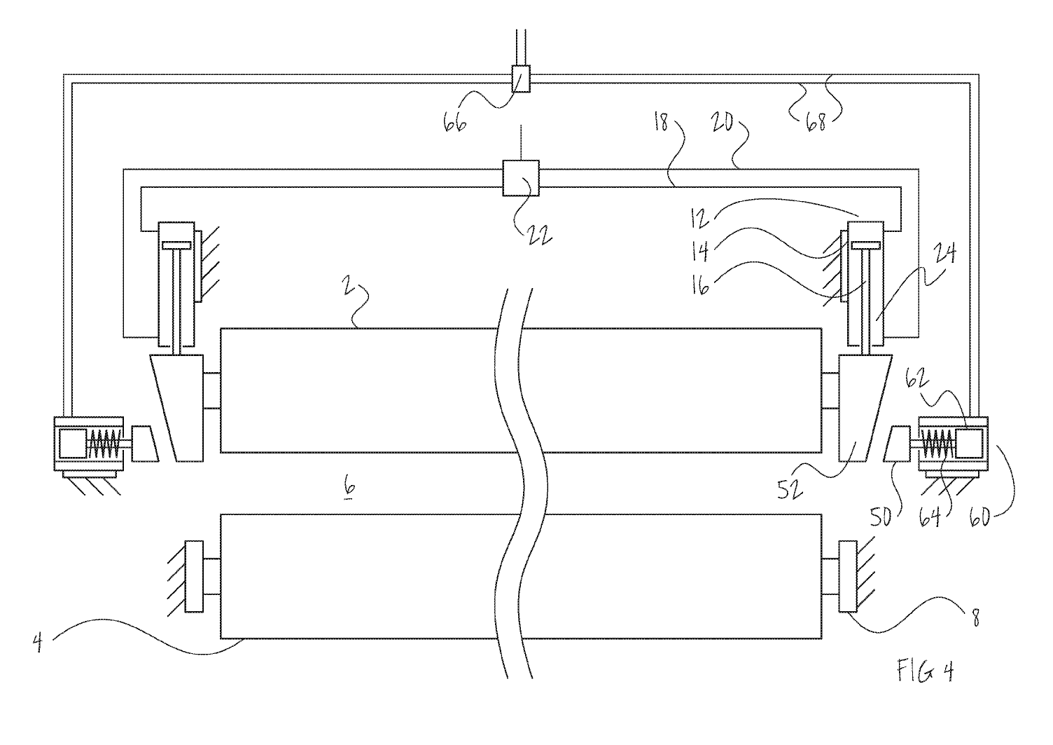

In a further embodiment of the invention, illustrated in FIG. 4, the locking assembly is operated electromechanically instead of pneumatically. Each lock 60 is again integrated within a housing of its respective cylinder and comprises a solenoid 62 that is controlled from a power supply 66 via wires 68. The solenoid may be operated to drive the first locking member 50 into engagement with the main piston 16. When power to the solenoid 62 is cut, a return spring 64 causes the first locking members 50 to disengage from the piston 16. In other respects, this embodiment is identical to that shown in FIG. 3.

Locks similar to those shown in FIGS. 3 and 4 may also be operated by purely mechanical means.

1-13. (canceled)

14. A laminator comprising:
first and second rollers mounted in parallel for counter-rotation;
a pair of parallel pneumatic cylinders, on which respective ends of the first roller are supported, whereby the cylinders can be operated to move the first roller towards the second roller; and
a locking assembly comprising a pair of locks that can be operated to act on the respective cylinders to prevent movement of the first roller towards the second roller.

15. A laminator according to claim 14, wherein operation of the locks does not prevent movement of the first roller away from the second roller.

16. A laminator according to claim 14, wherein each of the locks is integrated within a housing of its respective cylinder.

17. A laminator according to claim 14, wherein the locking assembly is operated pneumatically.

18. A laminator according to claim 14, wherein the locking assembly is operated electro-mechanically.

19. A laminator according to claim 14, wherein the locking assembly is operated mechanically.

20. A laminator according to claim 14, wherein the locking assembly can be operated at any position within a continuous range of movement of the cylinders.

21. A laminator according to claim 14, further comprising a common air supply for the pair of parallel pneumatic cylinders.

22. A laminator according to claim 21, wherein the respective cylinders are coupled to the common air supply via conduits of equal length.

23. A method of configuring a laminator having first and second rollers mounted in parallel for counter-rotation, comprising:
applying air at a first pressure to a pair of parallel pneumatic cylinders, on which respective ends of the first roller are supported, to move the first roller towards the second roller; and
operating a locking assembly comprising a pair of locks that act on the respective cylinders to prevent further movement of the first roller towards the second roller.

24. A method according to claim 23, comprising a preliminary step of placing a workpiece between the first and second rollers, wherein the step of moving the first roller is continued until the first and second rollers are both in contact with the workpiece.

25. A method according to claim 23, further comprising, after the locking assembly has been operated, applying air to the cylinders at a second pressure different from the first pressure.

26. A method according to claim 25, wherein the second pressure is higher than the first pressure.
